(19) United States
(12) Patent Application Publication
(10) Pub. No.: US 2009/0180085 A1
(43) Pub. Date: Jul. 16, 2009

(54) SYSTEM AND METHOD FOR LARGE FORMAT IMAGING

(75) Inventors: Kenneth J. Rieck, Victor, NY (US); Lotfi Belkhir, Victor, NY (US); Brian R. Hughner, Fairport, NY (US); Kevin W. Rodas, Victor, NY (US)

Correspondence Address: BASCH & NICKERSON LLP, 1777 PENFIELD ROAD, PENFIELD, NY, 14526, US

(73) Assignee: Kirtas Technologies, Inc., Victor, NY (US)

(21) Appl. No.: 12/353,753

(22) Filed: Jan. 14, 2009

Related U.S. Application Data
(60) Provisional application No. 61/021,318, filed on Jan. 15, 2008.
(60) Provisional application No. 61/073,584, filed on Jun. 18, 2008.

(51) Int. Cl. G03B 27/52

(52) U.S. Cl. 355/25; 355/77

(57) ABSTRACT

Disclosed are systems and methods for a flat platen imaging system. The system includes, either alone or in combination, a movable book support to facilitate the segregation and imaging of individual pages of an oversize book or similar bound document, and a user interface and visual indicators to facilitate imaging of a plurality of documents or document sections placed on the platen.

This application claims priority from U.S. Provisional Patent Application No. 61/021,318 for a “SYSTEM AND METHOD FOR IMAGING LARGE DOCUMENTS,” by K. Rieck, filed Jan. 15, 2008 and U.S. Provisional Patent Application No. 61/073,584 for a “SYSTEM AND METHOD FOR IMAGING LARGE DOCUMENTS,” by K. Rieck and L. Belkhir, filed Jun. 18, 2008, both applications being hereby incorporated by reference in their entirety.

Disclosed are apparatus and methods for a flat platen imaging system including a movable book support to facilitate the segregation and imaging of individual pages of an oversize book or large size document.

### BACKGROUND AND SUMMARY

The ability to acquire, convert, index and store a digital image of a hard copy original bound document has become important as a means to archive, as well as disseminate, the literal and illustrative content of a book, or other bound documents. The ability to digitally capture large-format documents, bound and unbound, as well as sensitive or rare documents is also important. Various government, educational, and commercial institutions have extensive libraries of books, oversize or large documents (e.g., maps, newspapers, etc.) and rare document or similar collections (e.g., coins/currency, letters, postcards, stamps, etc.) that they desire to convert into a digital image format to reduce the costs of storage, “back-up” or “archive” the hard copy, and most importantly to make the information available through electronic media for searching and acquisition. An additional reason for the desirability of the imaging a book or other document is the subsequent ability to manipulate the digital information for editing and compiling into an ASCII format by means of OCR or possibly into an audio file using text-to-speech software. Accordingly, there exists an increasing need for a system to readily manage the presentation of a large or oversized documents, or a plurality of documents, on a planar surface for the purpose of digitally capturing an image(s) thereof. Moreover, many such documents exist in the large or oversized format, which makes automated processing difficult if not impossible.

Numerous imaging devices are currently available that facilitate the handling of bound documents and are particularly adapted to sequentially presenting a page within the imaging plane of a scanner. Examples of such devices include a page-turning book scanner by Kirtas Technologies marketed as their APT Bookscan™ products and as described, for example, in commonly assigned and co-pending U.S. patent application Ser. No. 10/658,956 for an “AUTOMATED PAGE TURNING APPARATUS TO ASSIST IN VIEWING PAGES OF A DOCUMENT,” by T. Taylor and L. Belkhir, filed Sep. 10, 2003, which is hereby incorporated by reference in its entirety. Another page-turning scanning system is disclosed in U.S. Pat. No. 6,611,362, entitled, “AUTOMATIC BOOK PAGE TURNER FOR IMAGING,” and is also hereby incorporated by reference in its entirety. The term “binding” refers to an assembly whereby the sheets forming the document are held together by one of various methods such as gluing, stitching, stapling, clamping, etc. While binding often refers to books, as used herein it is further intended to include other multi-sheet documents that are retained as a set in some manner.

As will be appreciated the systems disclosed herein are capable of operation in several modes, including a mode that facilitates the imaging of large format documents such as books and the like, as well as in the mode of a flat platen imaging system where a plurality of documents or other items may be imaged serially in an efficient manner (e.g., rare documents, collections such as stamps, manuscripts, letters, coins/currency, etc.,—collectively referred to herein as “items” or “documents”). Support of the document(s) or item(s) during such imaging operations is important so that they are not stressed to a point where a page is damaged, yet allowing the document or item to be presented in generally planar position so information thereon can be illuminated and accurately positioned within the depth of field of the camera or scanner.

Although page-wise document scanners are known, as are manual, flat-platen scanners, such devices do not permit the imaging of large-format documents, or the serial imaging of a plurality of documents in an efficient manner. There remains an unmet need to facilitate the imaging of large format documents or a plurality of items that is facilitated by a multi-mode imaging system that enables positioning one or more documents in a flat or planar relationship to the imaging device, and that may further include supporting the remaining pages of a bound document in such a manner so as to avoid damage to the pages or the binding. The present disclosure is directed to an apparatus and method to accommodate the imaging of one or more documents on a flat image platen.

In considering the relationship of a book holder and an imaging platen for optimal page scanning of large pages, several factors are to be considered, including (i) preventing damage to the binding; (ii) illuminating and imaging the entire page binding region; (iii) supporting the book and avoiding stress on a binding; and (iv) providing suitable production efficiency while ensuring favorable operator ergonomics.

It is therefore an object of this disclosure to characterize, in detail, a flat surface imaging system having a platen that easily accommodates pages of a book or other large format documents, as well as multiple pages of smaller documents or items for imaging. In one embodiment, a thin platen edge intervenes between pages of the bound document in order to separate a page from the remaining pages while providing a planar support surface for the page being imaged.

It is a further object of this apparatus to provide a platen that holds the page in a flat position within the focal plane of the imaging camera(s) or scanner

In accordance with further aspects of the disclosed system, the digitization of large-format documents is facilitated by various techniques that improve the ability of the system to capture high-resolution digitization information. Including, for example, a support structure for the remaining pages of a bound document to prevent stressing or damaging the binding.

In accordance with yet another aspect of the disclosure an operator processes and images a bound document using a movable support surface that moves in the manner of a shuttle to facilitate support of the document as well as changing of pages presented for imaging.

A further aspect of the system facilitates the sequential, controlled capture of portions of documents, or of a series of documents, using automated image capture controls, and possibly image stitching to create digital images of large documents from a plurality of high-resolution image sections. In another mode, the system operates to capture a plurality of images of items placed in a spaced-apart relationship in accordance with a grid that may be selected from a user interface, and/or depicted using light (laser markers) or similar indicators on or adjacent to the document being digitized.

Yet another aspect of the disclosed system facilitates user-controlled operation of the imaging hardware to enable the capture of all or portions of a large format document, or of a plurality of documents, without the need to manipulate the document(s).

Also disclosed herein is an advanced user interface for controlling the operation of a plurality of controls associated with the system, thereby improving the efficiency of digitization of large format documents and books or a plurality of documents placed on the imaging platen.

These and other objects, as will be apparent herein, are accomplished by providing an imaging system comprising a platen within a chassis having an imager and illumination source mounted thereon. In one embodiment, the system further comprises a movable book support structure operatively associated with the platen which transverses or shuttles between a first position, that is adjacent an edge of the platen, and a second position separated from the edge where the book may be placed on the support. The total longitudinal travel distance, between the first and second positions, may be up to or at least about as large as the width the page of the opened book to facilitate turning of the pages when the support is in the second position.

Other and further objects, features and advantages will be evident from a reading of the following description and by reference to the accompanying drawings forming a part thereof, wherein the examples of the various embodiments are given for the purposes of disclosure.

### BRIEF DESCRIPTION OF THE DRAWINGS

FIG. 1 is a perspective view of an exemplary imaging system;

FIGS. 2-3 illustrate various views and aspects of the imaging system;

FIG. 4 is a perspective view of the exemplary imaging system in use by an operator;

FIGS. 5-10 are exemplary illustrations of user interface screens employed in the control and operation of the imaging system;

FIGS. 11-13 illustrate the use of a grid or template for imaging multiple sections of the imaging system platen and further depicting automated, serial movement of the imager through the image sections;

FIGS. 14-17 illustrate variable lighting aspects of the imaging system;

FIGS. 18 and 19 are close-up views of a corner of the platen showing ruled indicators along the edge thereof and illustrative examples of the relationship between the user-interface template selection and the laser-projected template grid;

FIG. 20 is a diagram depicting components of the imaging system of FIG. 1 from a rear view;

FIGS. 21-23 are illustrative examples depicting operations for placing a page of a large document on the platen of the imaging system;

FIGS. 24 and 25 are simplified diagrams illustrating the relationship between the platen and book support shuttle; and

FIG. 26 is a representative flow chart of an imaging process performed with the imaging system disclosed herein.

The various embodiments described herein are not intended to limit the invention to those embodiments described. On the contrary, the intent is to cover all alternatives, modifications, and equivalents as may be included within the spirit and scope of the following description and claims appended hereto.

### DETAILED DESCRIPTION

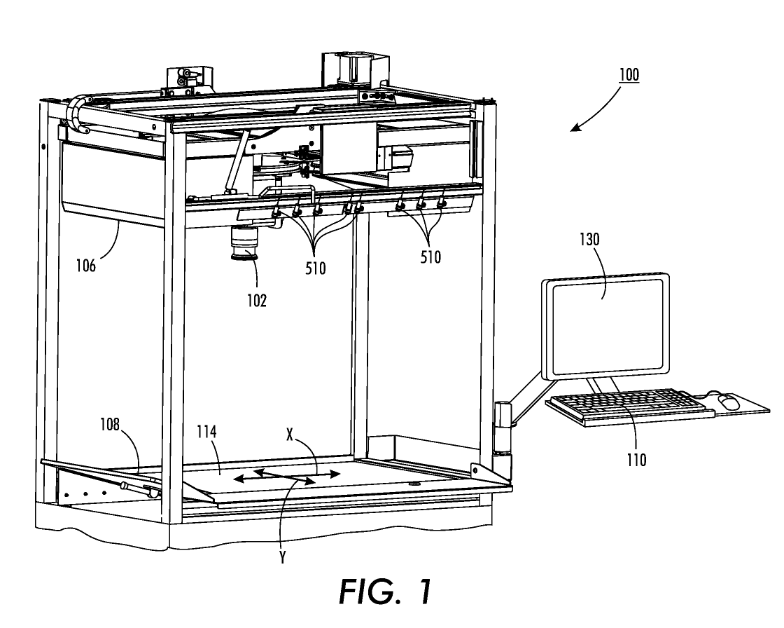

Referring now to the drawings shown for the purpose of illustrating various embodiments of the system and method, FIG. 1 shows an imaging system 100 for generating a digital image representative of a document(s) placed on the surface of platen 114. The flatbed imaging system captures about a 35″×25″ view of the platen using a 21.1 megapixel, high-resolution Canon EOS 1Ds Mark III digital camera, in one embodiment (EF-24-105 mm zoom, EF 85 mm fixed and EF100 mm fixed lenses may be used). The image data may be captured in color, 24-bit (RGB) format, and the system features a motorized overhead camera or imager that controls position of the imager for single or multi-document imaging modes. In the multi-document modes, lasers can be used to illuminate the surface of the imaging platen in order to facilitate placement of the documents or items being imaged. The system operates on standard US and European power, and includes a computer (PC) workstation (not shown in FIG. 1) as the system controller and image capture platform (e.g., SkyView™ from Kirtas Technologies, Inc.)

It will be recognized that while the description of system 100 refers to an imager or a scanner, the system has a broad application, which may include front-end and back-end image processing functions. Such image processing functions, although not described in detail, may be considered to be incorporated in the disclosed embodiments, and may include image filtering and correction, editing (including automated stitching of serial image sections), indexing, optical character recognition, compression, filing, searching, retrieval, faxing and reproduction, to cite a few. Usually, although not universally, the text and images on each page are oriented from top to bottom along an axis parallel to the binding of the bound document.

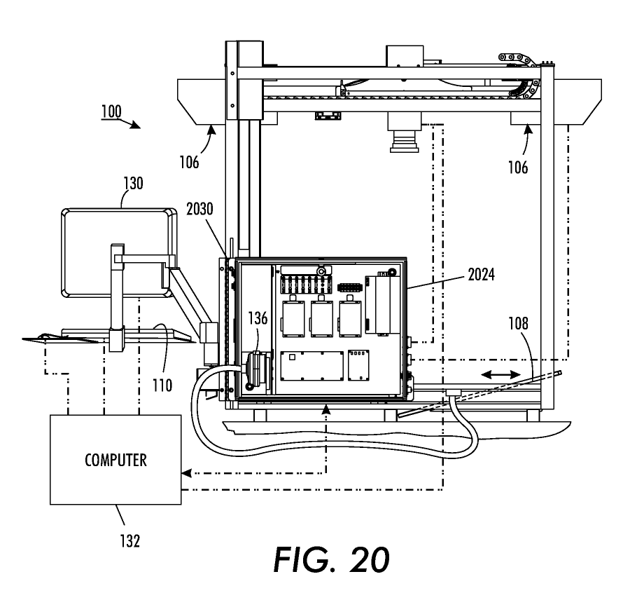

Referring to FIGS. 1 and 20, the system comprises several subsystems including an image processing unit such as a computer processor (132; e.g., a computer workstation with a standard operating system and which preferably includes image capture and processing software as well as a dedicated or networked memory or other storage media), video display 130 providing a user-interface for system 100 thereon, vacuum source (136), imager 102, illuminator/light source 106, platen 114 and document support shuttle 108. In one embodiment the workstation operates under the control of Bookscan™ software available from Kirtas Technologies. Such software, as well as other imaging software is known to facilitate imaging using cameras and other imaging devices. Moreover, the software preferably provides features such as deskewing, cropping and even optical character recognition. In an embodiment suitable for use with large-format imaging, the Bookscan software may be modified to incorporate an image stitching operation whereby the large-format image may be captured as a plurality of adjacent and overlapping images, and then stitched together. For example, the functionality of Autopano™ software by Kolor may be used in a manual or automated/integrated mode to stitch together several adjacent image sections in order to output a large-format image made from several smaller, high-resolution images. As described in more detail below, the “stitch” mode of the Bookscan™ software facilitates the collection of overlapping images in order to provide reference points for the stitching software to operate.

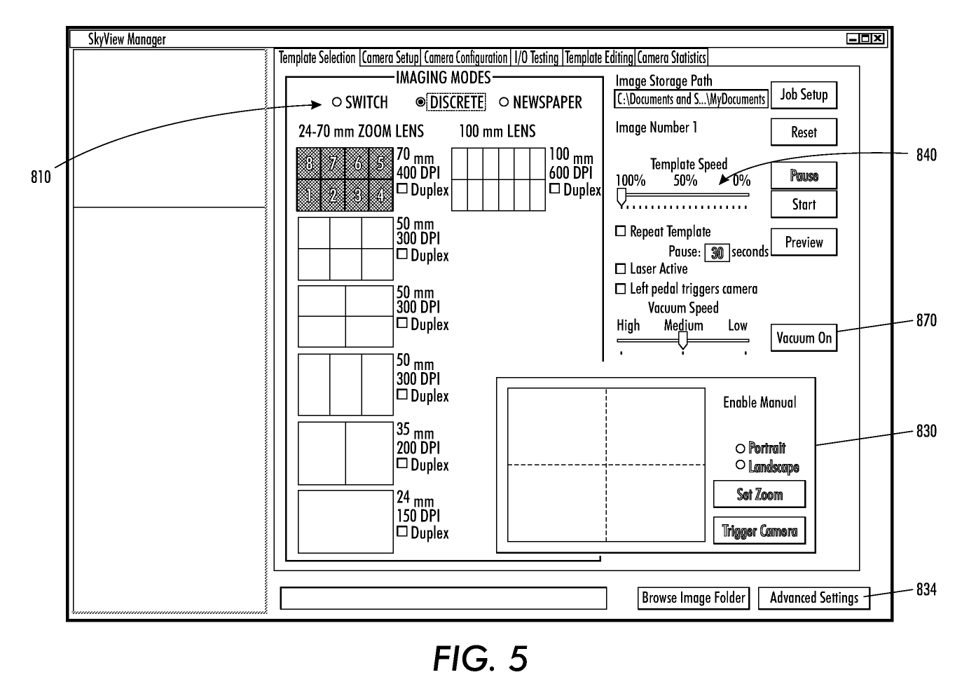

The vacuum (V) source 136 may be any of a number of pneumatic-type devices suitable for producing a reduced air pressure or vacuum, and in one embodiment an Ametek Minijammer™ was used to provide the vacuum source. It is also contemplated that the level of vacuum applied to platen 114 by the vacuum source may be controlled by the user or automatically, perhaps using a potentiometer or similar device for controlling the power applied to the source. Moreover, as depicted in FIG. 5, the vacuum source is responsive to controls 870 provided on the user interface, with a slide bar to select between at least a low, medium and high speed for the vacuum blower. The vacuum source, various motor drivers (controlling imager X, Y and Θ movements), and other non-computer electronics are, in one embodiment, located within a separate enclosure 2024 (see FIG. 20) that may be connected via a hinge 2030 to the system, thereby providing access to the enclosure, and allowing the enclosure to be swung relative to the remaining pieces of the system thereby permitting the system to fit through most doorways without disassembly. Enclosure 2024 further includes motor controllers for motors providing X, Y and Θ movement of the imager, as well as various AC/DC electrical connections for lights, lasers, etc.

As previously discussed, support of the documents is important so that a user or operator is not required to hold the book or page in place for imaging, and to permit the imaging of fragile and rare documents, so the document may be scanned without damage. For bound documents, document support shuttle 108 provides a canted or oblique surface that moves the bound document (not shown) transversely along a path extending substantially beneath platen 114, while at least one page may be segregated and drawn onto the upper most surface of platen 114. Once a document(s) is in position, illuminator 106 produces light that is reflected from the document and platen into an imager such as a digital camera 102 in order to capture a digital image of the document(s). Although a digital camera is depicted, it will be appreciated that a custom-designed imaging system may be employed including alternative camera and/or scanning systems. The processor acquires the image data from the imager and places a frame of the image into a file format (e.g., JPEG, TIFF, bit-map, etc.) for subsequent processing and/or storage.

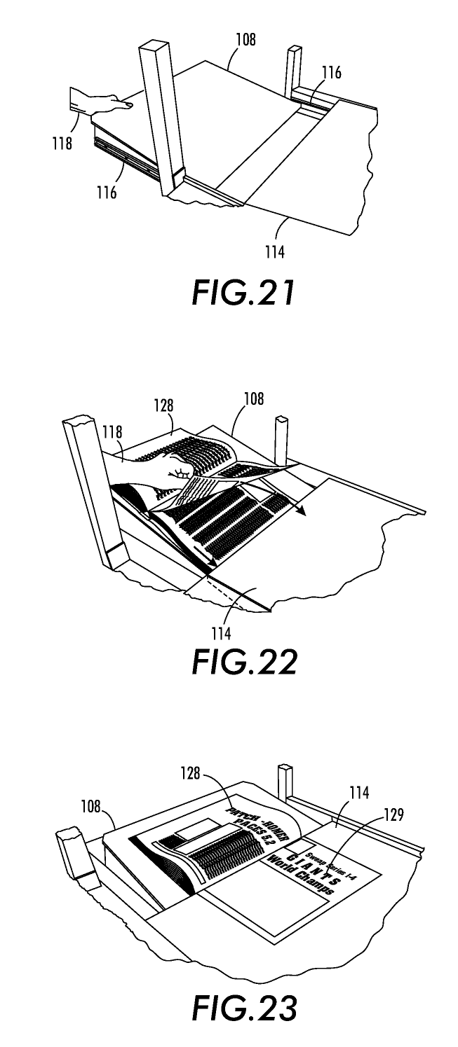

A moving support for the bound documents is shown along the left side of FIG. 1. Also referring to the detail in FIGS. 21-25, the support comprises a shuttle 108, shuttle rail 116 and the vacuum platen 114. Notably the upper-most surface of shuttle 108 is canted or angled relative to the generally horizontal surface of platen 114, and the shuttle is movable along a common plane generally parallel to platen 114 along rails 116. Therefore, shuttle 108 supports bound document 128 thereon, and is capable of translating towards and even beneath the underside of vacuum platen 114 as shown in FIGS. 22-23. In FIG. 23, the right side of opened bound document 128 is now supported at a position underneath platen 114 while page 129 has been segregated for imaging as the leftmost edge of platen 114 is inserted between page 129 and remaining pages of bound document 128.

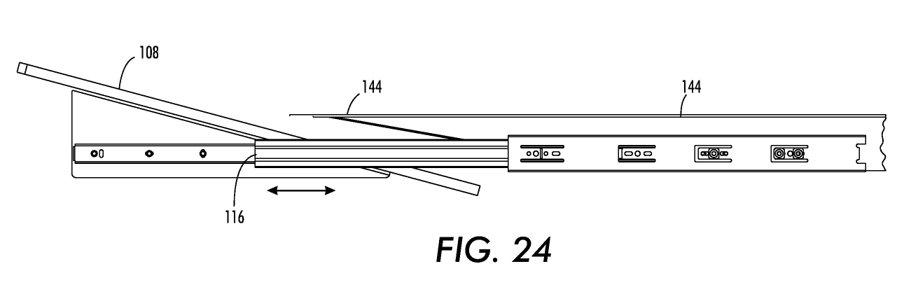

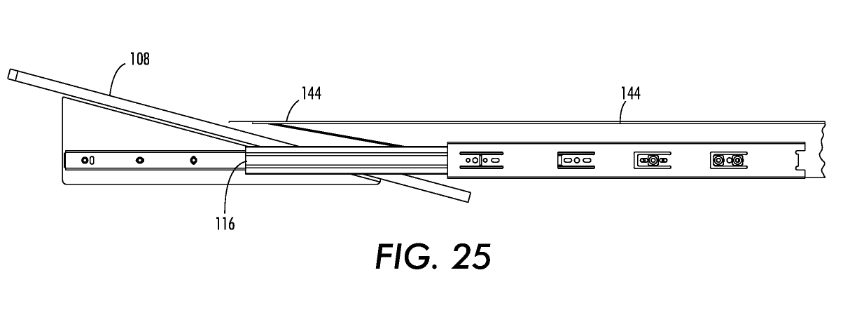

Also referring to FIGS. 24 and 25, shuttle 108 is caused to stop as the wedge shaped leading edge of platen 108 engages the binding of document 128, thereby all but eliminating any curvature of page 129 due to the binding. The supporting surface shuttle may also be locked or stopped in this position in the event that the force of the binding against the platen edge tends to move the shuttle away from the platen. Any of a number of mechanisms may be used to secure the shuttle in a position, including door-stop like mechanisms, pins, detents in the slides (e.g, like a self-closing drawer slide), etc. Moreover, such mechanisms may be manually controlled by an operator or may be responsive to programmatic or other types of automated or remote controls (e.g., foot switch). The relative motion and geometric relationship between platen 114 and shuttle 108 are shown in schematic form in FIGS. 24 and 25. In actual practice it is understood that the position of bound document along the inclined surface of shuttle 108 may be a direct function of the number of pages compiling the portion of the document that is to be positioned beneath platen 114. As shown in FIG. 25 the position of a relatively thin document 128 would be somewhat central on shuttle 108 whereas in FIG. 24 the document would need to be biased towards the proximal side of shuttle 108 because as the shuttle moves inward the gap, as indicated with the vertical arrows, diminishes to allow the leading edge of platen 114 to align with the binding at the point of attachment of a segregated page 129.

Once the segregated page has been positioned on the surface of platen 114, within the scan area, a vacuum is applied to the platen from the reverse side to cause the document to become fully engaged with the generally planar upper surface of the platen. It is well known that the limited beam strength of relatively thin material, such as paper, causes it to wrinkle, fold and curl absent a normal force. Therefore, the advantage of applying a vacuum is that it forces and holds the page in a flat position and thereby ensures that the entire page is within the depth of field of lens 104 on the imaging camera. Flattening the segregated page 129 further mitigates the potential for shadows or irregular illumination from light source 106.

In one embodiment, platen 114 may be a painted or reflective surface, having holes to permit the application of a vacuum to the underside to attract documents on a top surface. In another embodiment, as depicted in the figures, the platen includes an air-permeable material over the surface of the platen to both provide a contrasting color for imaging (e.g., black, or white material color). The material may be a woven nylon over a felt underlayment, but such a combination may be subject to wrinkling/puckering in high-humidity environments. Alternatively, the material may be a stretchable fabric that can be placed under tension (taut) and anchored along the edges (top or underside) of the platen so as not to move or wrinkle with temperature and humidity changes. One suitable material is a replaceable felt overlay sold as an interface or stabilizer material, sold by Pellon as Peltex 70™, which is available in black or white in order to provide a contrast to the item(s) being imaged.

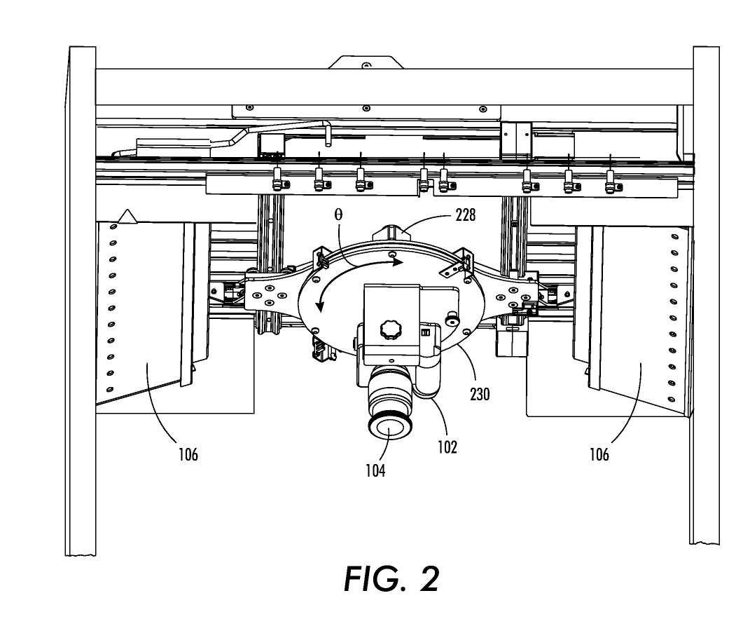

Having described the basic components of the system, the following description is intended to provide further details of the operation and interrelated functions of the aforementioned components to achieve the dual-mode (large-format document and multi-document) imaging. With reference also to FIGS. 2-4, suspended above platen 114, via chassis frame 210, is imager 102, which may be a digital camera and lens as depicted in the embodiments herein. Imager 102 is positioned for imaging above the platen for imaging the documents(s) placed on the platen.

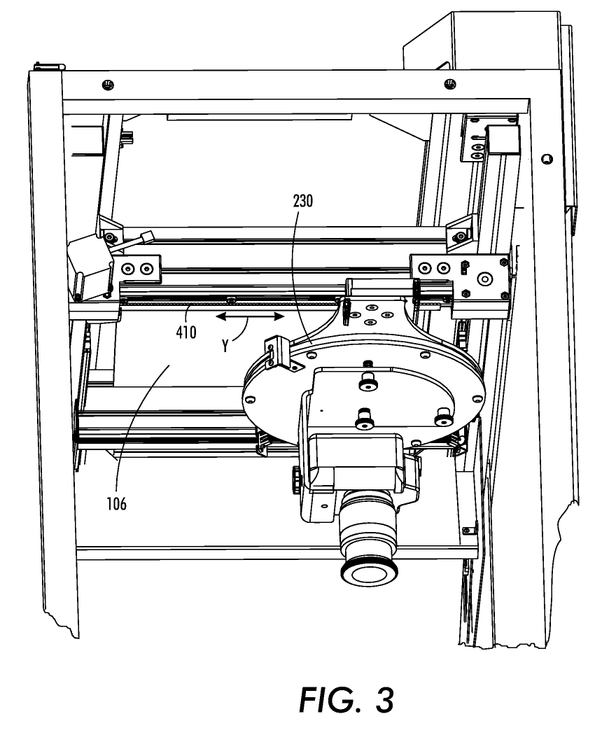

In one embodiment, imager 102 is attached to a carriage having a rotatable disk 220, which is driven by a motor (e.g., stepper or servo) in conjunction with a geared transmission (see ref. 228) under the control of the computer processor 132. For example, the imager and its carriage are connected to the chassis using a conventional X-Y axis gantry, permitting the imager to be positioned to capture most any portion of the platen below. The orientation Θ (e.g., landscape (0°), portrait (90°), angled (N°)) of the imager camera with respect to the chassis and platen is controlled by movement of the disk 230, and it's position is monitored and controlled in response to the user's selection via the user interface and under programmatic control of the imaging system. It will be appreciated that rotation of the imager is about the longitudinal axis of the lens and, if not, that positional adjustments may be required to adjust the lens position when the imager is rotated. The X-Y position of the imager 102 is preferably controlled by stepper motors having a gear engaging a toothed linear track or belt 410 as generally depicted in FIG. 3, where the imager carriage is moved along the Y-direction in response to the motor driving a gear engaged with the track 410. It will be appreciated that alternative X-Y and Θ drives and controls (e.g., lead screws, belts/pulleys, etc.) may be employed to control the X, Y and Θ positions of the imager 102 in relation to the platen. It is also contemplated that the imager may be controlled manually, or possibly even mechanically fixed in at least the X-Y position in a de-featured embodiment. Collectively, the X-Y and Θ controls form a position controller (under the programmable operation of the processor) for controlling the operation of the imager. It will also be appreciated that the controls employ various sensors, switches or the like to sense travel limits, defined and/or default (home) positions of the various drive paths so as to reliably position the imager relative to the platen 114.

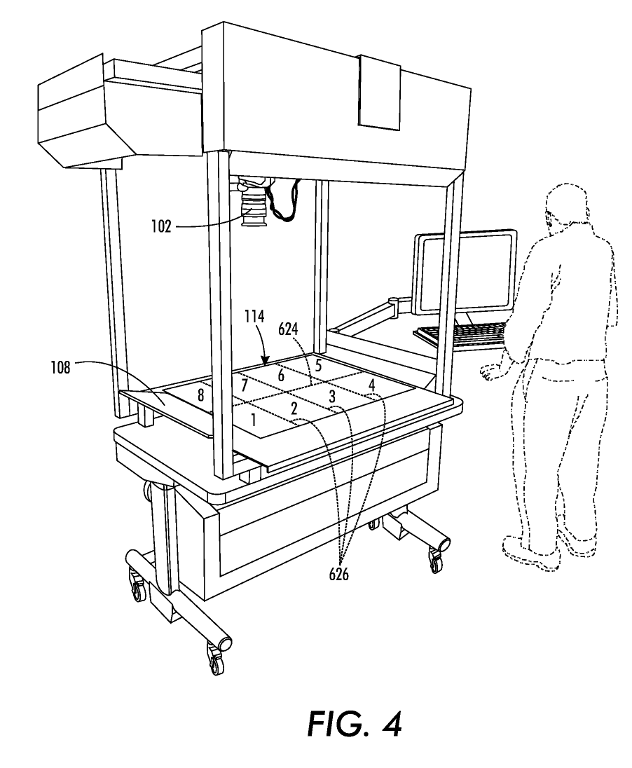

Referring again to FIGS. 1 and 20, vacuum platen 114 is a central component of system 100, and provides for a planar surface positioned within the focal plane of imager 102. In conjunction with imager 102, there is an associated lens that makes the imager or camera capable of capturing, digitizing and transmitting digital data as a digital representation of a document(s) placed on the platen. As will be described below relative to FIGS. 4-5 and 11-13, the system may be operated in a mode where a plurality of documents or items are placed on the platen surface for sequential imaging. It is believed that such a mode permits the efficient digitization of rare and fragile documents that will be handled by an operator.

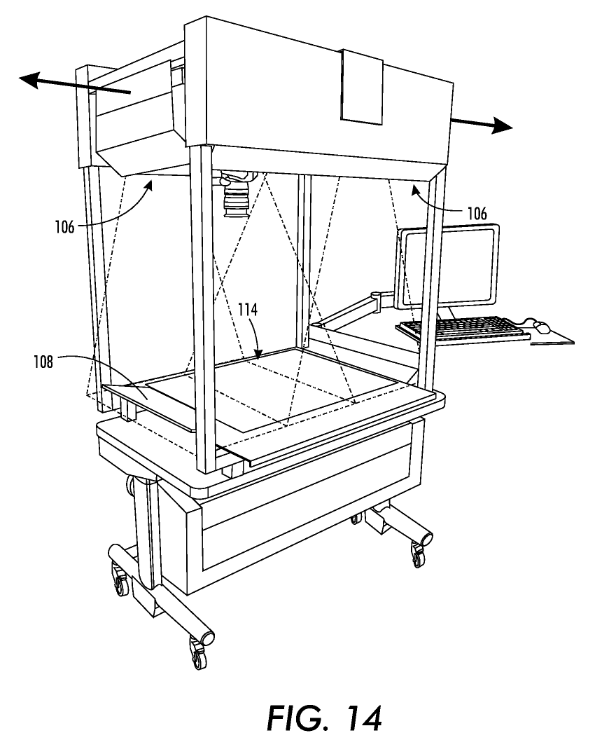

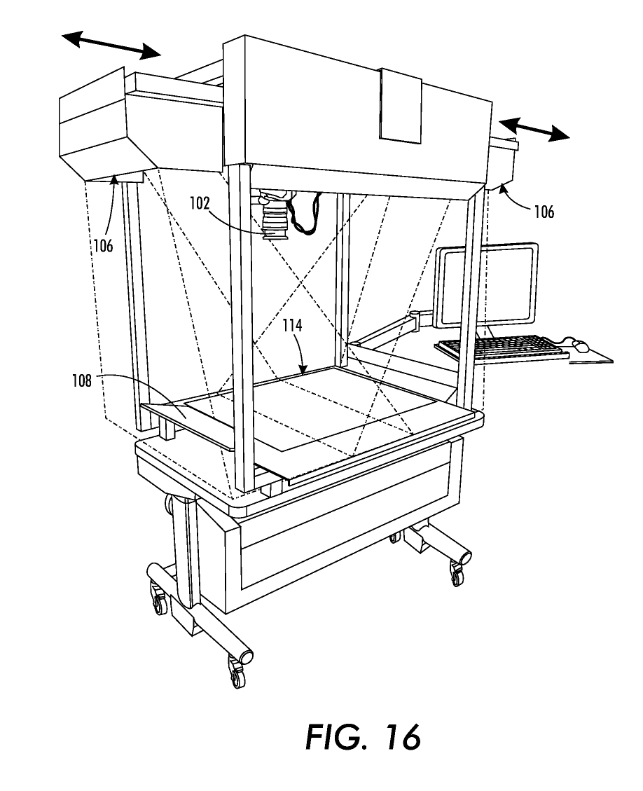

The digital data may be stored on the processing unit (e.g., computer 132) in RAM or on disk, and may also be stored on networked devices and memory (not shown) in a conventional image file format. Imager 102 creates electronic data representative of the page at a resolution measured in pixels (i.e. dots per inch) that is a function of the resolution of the sensor, for example a charged coupled device (CCD), be it a matrix or linear array. In one embodiment, imager 102 is a Canon EOS Mark II or III camera with one of a plurality of optional lens configurations. However any suitable image sensor may be used that provides a proper digital image that can be stored in memory. The lens on the imager serves to focus the light from illuminator 106 as reflected from the page(s) on the platen 114. Illuminator 106 produces diffused, non-collimated, light rays that travel in many different directions to provide a flat, uniform illumination to enable the detection of grey scale shades, since light radiated in a number of different directions is incident onto vacuum platen 114. Those familiar with the optical characteristics of camera lenses will appreciate that the illumination may need to be adjusted, as represented by FIG. 16, to assure adequate or appropriate distance is provided between the light source and the platen to avoid or reduce glare. Such a situation is represented by FIGS. 14-17, wherein upon changing the desired imaging area in the Template Selection portion of the user interface, the system prompts the user to adjust the position of the illuminator, moving the illuminators in or out as indicated by the dialog boxes 1710 and 1510, respectively.

In one embodiment, illuminator 106 is the same as used in the Kirtas APT Bookscan™ models, employing slightly higher wattage in the bulbs due to an increased illumination area (for example, four 57-watt bulbs). For example, the wattage is increased such that at least about 200+ watts of light power are provided on either side by high-intensity compact fluorescent (Phillips™ PL-H; 120 W and 85 W) bulbs. Also contemplated is a removable illuminator that permits the entire illumination system to be disconnected from the system and an alternate illuminator substituted. Such a feature would enable specific illuminator designs (power, light type, etc.) for various items being imaged on the platen.

In one alternative embodiment, for example, a device suitable for imaging bound books or other documents wherein the surface being imaged may not be relatively flat, the light source may be modified to provide less radiating exposure. Such a light source may include, as replacement of or in addition to a diffuser, a series of parallel baffles that serve to provide a more collimated source of light. The collimated light source is believed to reduce imaging artifacts caused by diffused light and the multiple angles at which such light is reflected from non-planar document surfaces. Thus, the lights in illuminator/source 106 may include a plurality of generally aligned baffles to provide aligned or collimated rays of light for reflection off of a document.

Turning now to FIGS. 1, 4 and 11-13, when imaging a plurality of documents or items, they may be placed at any position on platen 114. However, given the size of the platen it is possible, depending upon the size of the documents, to place a plurality of documents on the platen surface for sequential imaging. For example, if a rare collection of letters were to be captured, the letter pages could be laid out in a pattern and sequentially imaged so as to avoid imaging one at a time as with convention flatbed scanners. To assist with the layout of the documents, one embodiment of system 100 contemplates the use of visual indicators to indicate the regions in which documents or items to be imaged are placed. The visual indicators may be provided through a number of means (LED's, lines on a translucent/backlit platen surface, etc.), but in the depicted embodiment, the indicators are provided by small lasers 510 (FIG. 1) that project along pre-defined locations of the platen to produce a grid of lines 620 as seen in FIG. 4 (laser-projected grid lines 624 and 626 in various configurations are depicted). Line 624 divides the platen along the Y-axis, while lines 626 divide the platen along the X-axis.

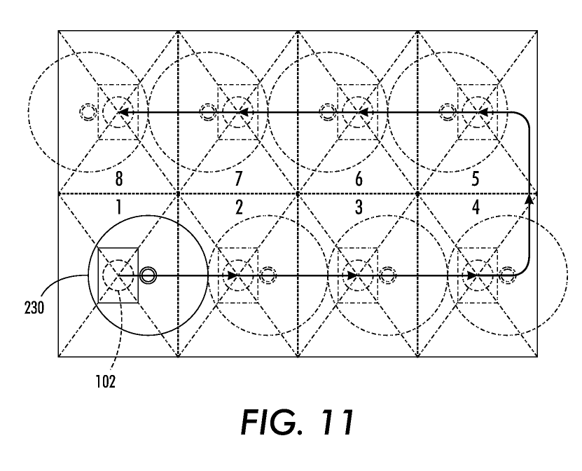

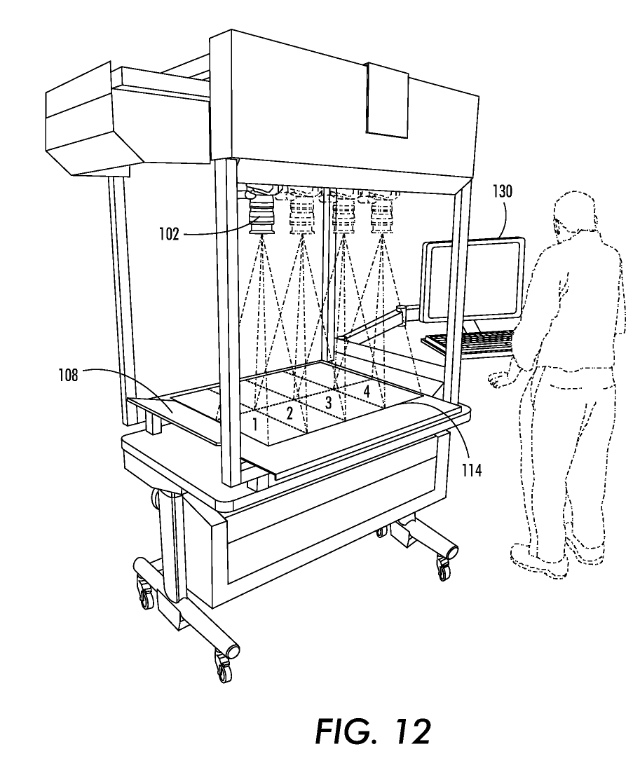

As depicted in FIG. 4, platen 114 may be divided into eight sections using the laser-produced grid, and the user of the system can then place a document within all or some of the sections 1-8. The section numbering also indicates the default order in which the various sections will be imaged, so that if the user desires to have the documents imaged in order they should be placed in the indicated order of 1-8 for serial imaging. As depicted in the user-interface screen of FIG. 5, a user may alter the imaging sequence to meet preferences or requirements for particular jobs. An alternative image capture order, other than 1 through 8, may be selected depending upon the type of documents being imaged, user preferences, speed of acquisition, etc. Upon beginning the capture of images for a plurality of documents laid out in the platen grid as depicted in FIG. 4, the imager is first moved to its home position (over the front left corner of platen 114, as indicated in FIGS. 11 and 12). Using the user interface as depicted in the display 130 of FIG. 12, the user can control/select with the keyboard 110 and optional mouse (or alternatively a touch-sensitive display), the desired layout (grid structure) for the documents. As noted above, selection of different grid configurations results in adjustment of the visual indicators projected on the platen for aiding the user with positioning the documents.

Once documents are placed on the platen the imaging operation may be started. If desired, a vacuum is applied to the platen from the reverse side so as to cause the documents or items to become fully engaged with the planar surface of the platen. The advantage of applying a vacuum is that it forces and holds the page in a flat position and thereby ensures that the entire page is within the depth of field of imager 102. Flattening the documents further mitigates the potential for irregular illumination.

Turning next to FIGS. 5-10, depicted therein are various views of the user-interface that is available via display 130. In the embodiment described, all available user interface screens are illustrated (see “Advanced Settings button 834, however, only two tabs (e.g., template selection and camera setup) are available to the typical user. The remaining tabs are only available at a service or administrator level for the system. Such tabs are accessed through the Advanced Settings button found in the lower right corner of FIG. 5, etc. and then insertion of a password or similar feature.

In FIG. 5, as previously described, is the template selection tab, where a plurality of document layout templates are set forth. Along the left side of the displayed interface, a portrait templates selection block includes seven different templates that may be selected for imaging in a portrait orientation of the imager. Options include 8-up (2×4), 6-up (2×3), 4-up (2×2), 3-up (1×3) and 2-up (1×2) configurations for a 70 mm zoom lens and a 12-up (2×6) configuration for a 100 mm zoom lens. The templates are varied based upon the imaging mode chosen. Depicted in FIG. 5, region 810, are three operating modes: stitch, discrete and newspaper. The discrete imaging templates are illustrated and are similar to the stitch templates, although in the stitch mode the images captured are slightly larger than the indicated templates to enable stitching along the segment borders. In newspaper mode, the templates are more limited and the template regions are used to select those portions of the platen in which an image is to be captured (so as not to needlessly image portions of the platen in which no document or item is present).

In the center of the interface screen are two landscape templates, 4-up (2×2) and full platen, that may be selected. In region 830 a button is provided to select manual control of the position of the imager—where the position is controlled in response to movement of the mouse cursor within the platen graphic in region 830. In the same interface screen, along the right side is a speed control 840, where the speed at which the imager moves from one template (grid) position to the next sequential position is controlled. This enables a user to selectively control the speed at which documents/items are imaged and thereby the speed at which the documents/items can be flipped for reverse-side imaging or replaced for imaging of subsequent documents/items. Such a feature allows the speed to be tailored to the manner in which an operator wishes to proceed. If no handling of the documents has to occur, then the highest speed may be desired. The Repeat Template checkbox indicates that the imager should repeat the capture process once all sections of the grid have been imaged. The Lasers Active checkbox is used to enable/disable the projection of the grid on the platen using the lasers as described above.

Along the top of the user interface screen in FIG. 5 is an image storage path field that may be accessed by the user in order to specify where the images captured by the imager are to be stored. Moreover, the naming convention of such files is in accordance with the imaging mode. In other words, if a plurality of documents are being imaged using a template, then the file names for the related digital images may include sequential numbers. Alternatively, for a duplexed set of documents, where both sides of the page are to be imaged, the front pages may include only odd numbers and the reverse (back) pages may included the intervening even numbers so that collation of the images is facilitated using the file names. For example, using the 8-up template to capture a set of double sided documents, the first few pages would be named page1, page3, page5, etc. and as all eight pages are imaged they are then flipped by the user and the imager then repeats to capture the reverse or back sides as page2, page4, page6, etc. As stored and later compiled, it is then easy to see the pages in their intended “reading” order.

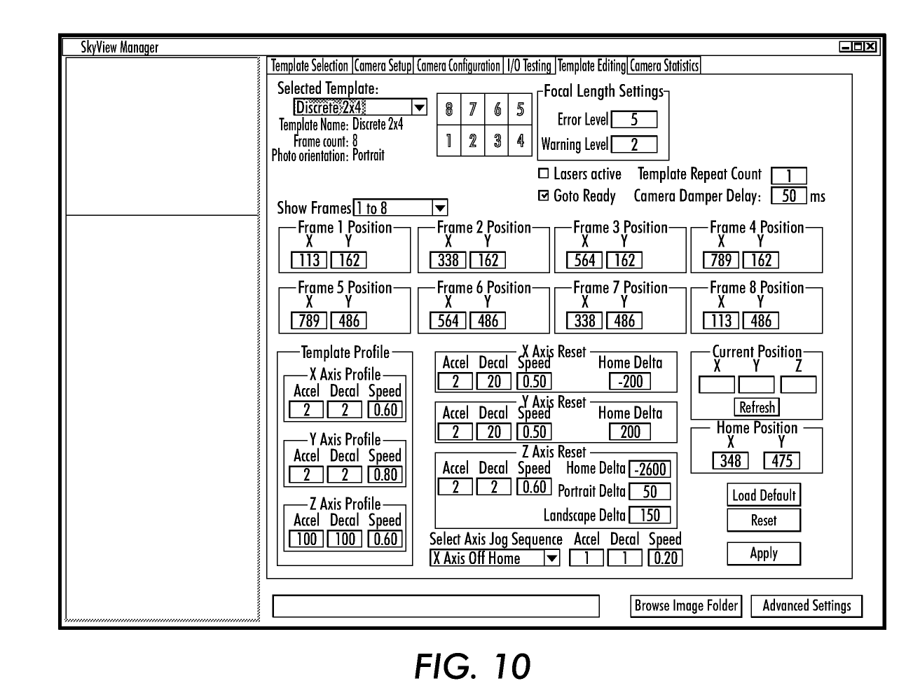

The templates stored and used by the system may be selectively adjusted or edited using the Template Editing tab as depicted in FIG. 10. Referring to FIG. 10, the various editable fields in the interface provide the user with the option to specify particular templates for re-use, where the position of the imager is controlled relative to one or more sections of the platen. In addition to setting up templates, the Template Editing tab further provides Profile fields that enable the user to customize the templates and control the characteristics of the imager travel (e.g., speed as well as acceleration and deceleration).

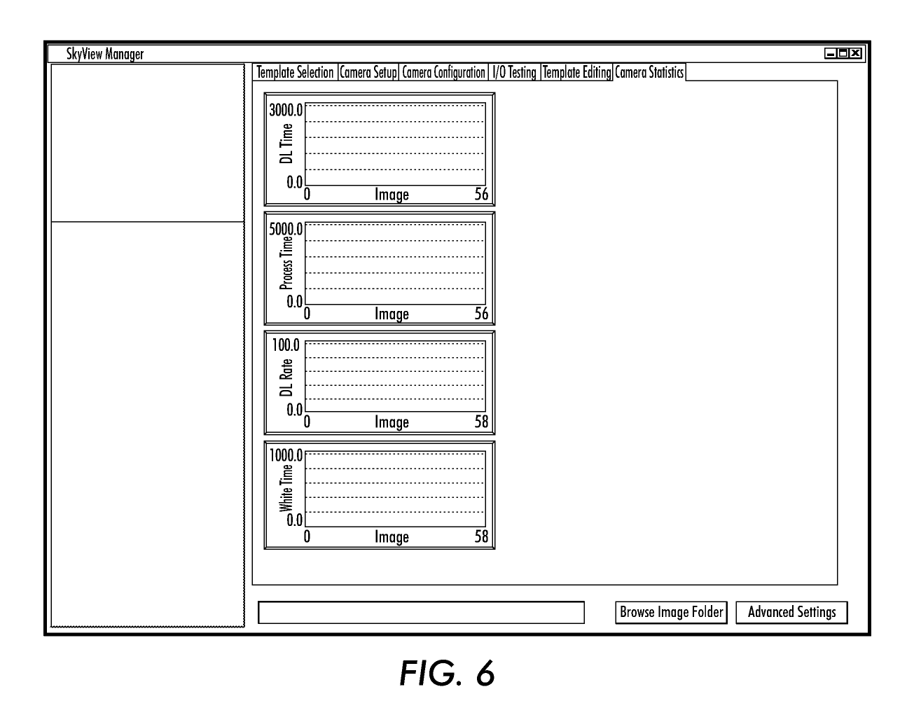

In FIG. 5, the interface screen for the Manual Control is depicted. In one embodiment the interface may provide the user with reduced-size (thumbnail-like) images for those that have been recently captured. Each image may be selected to view an enlargement, and information associated with the image (e.g., file name) may be displayed and edited below the image. Using the preview feature, the processor captures a region of the platen defined as the scan or photo region and forms the image upon the display screen. It may simultaneously present the screen image for indicating the portion of the image to be processed, so a user can determine whether a page is positioned in a desired orientation before committing the image to memory. Selection of the preview button initiates the ability to view the platen image in real-time through the lens of the imager camera, to see what the camera is seeing. This preview feature displays the image on the screen, and enables imaging feature adjustment and setting up custom template configurations as well as control of zoom, etc. Referring to FIG. 6, the Camera Statistics tab illustrates graphs with information pertaining to the imaging process.

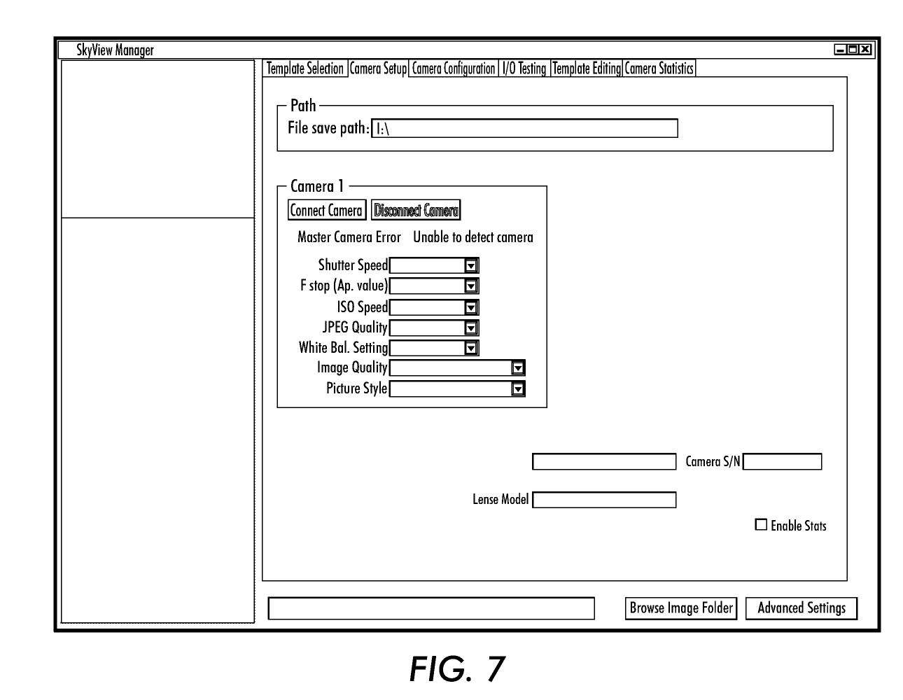

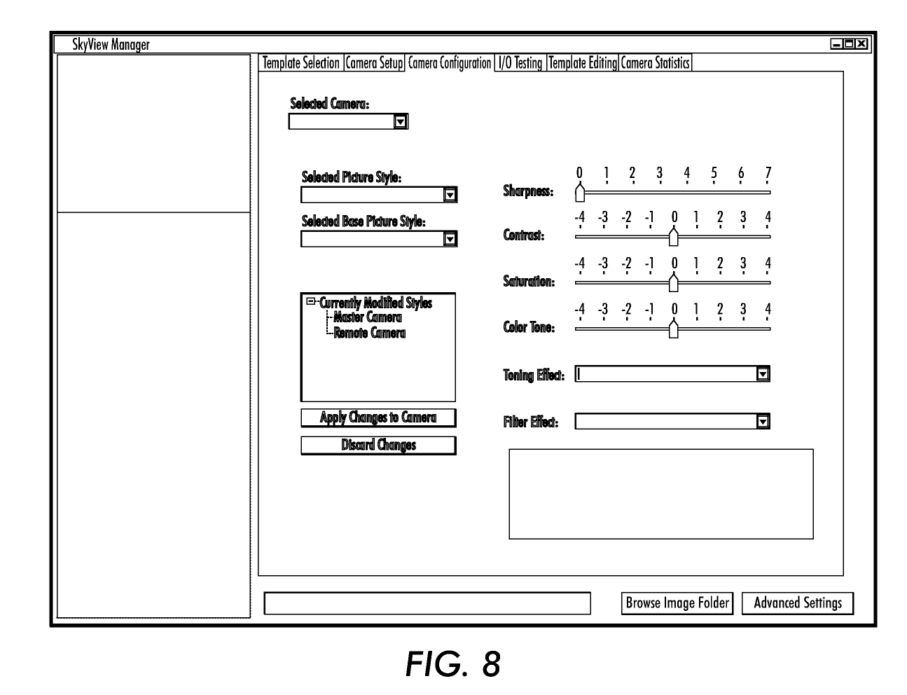

In FIG. 7 the Camera Setup tab screen is depicted. Here, various controls for the digital camera (imager 102) are provided for the user to control camera operation, as well as default file paths for image files being captured. The features controlled using the Camera Setup and Camera Configuration tab (FIG. 8) are used to control the capture and storage of the document images. As seen in FIG. 8, the interface also controls the image characteristics (e.g., sharpness, contrast, saturation and color tone, and further permits the specification (and editing/saving) of various configurations and cameras, which may be interchanged depending upon the nature of the documents being digitized.

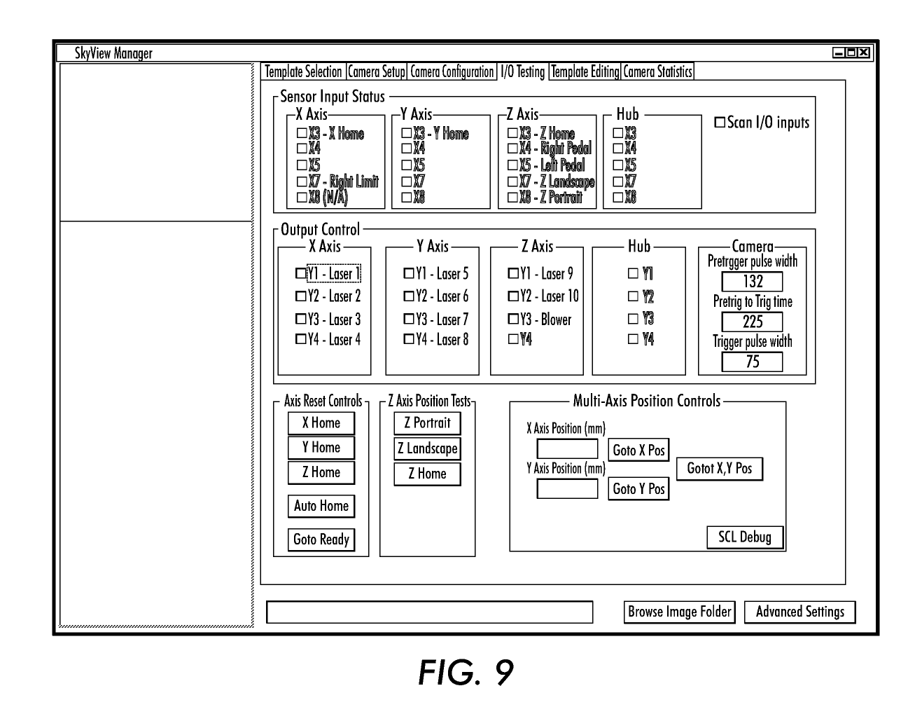

FIG. 9 is the interface screen associated with the I/O Testing tab of the user interface, and provides various diagnostic and control functionality for an advanced user or service representative. FIG. 9 provides an interface for exercising the various features and functions of the system 100, where the input and output functionality of the system may be exercised. FIG. 10 is a Template Editing interface permitting the modification of the template settings, including positions.

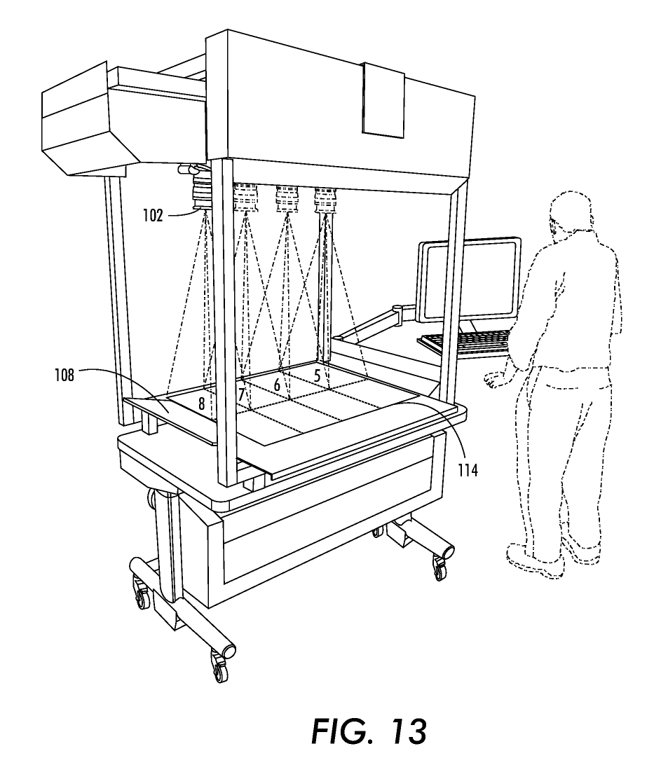

Turning next to FIGS. 11-13, there are depicted a series of illustrations that depict the sequential movement of the imager in relation to the selected template. More specifically, it will be seen that on the user interface screen the upper-left, 8-up portrait scanning template has been selected. As can be seen by a review of the figures sequentially, the imager moves to the right, in FIG. 12, through a series of four positions along the front of the platen, and then moves to the back of the platen and returns moving leftward through the four positions to complete the capture of eight different image sections as shown in FIG. 13. In one embodiment, this enables the capture of a plurality of documents or items placed on the platen in the grid described and depicted above in FIG. 11. It is further contemplated, however, that instead of a plurality of documents, the sequential imaging may be used to capture higher-resolution sections of a large-format image which could then be digitally “stitched” together in order to provide high-resolution image capture of large-format documents (bound and unbound). As described above, FIG. 14 is an illustration of the system with the imager in the home position, where the imager, and associated lens) may be adjusted for focus, etc.

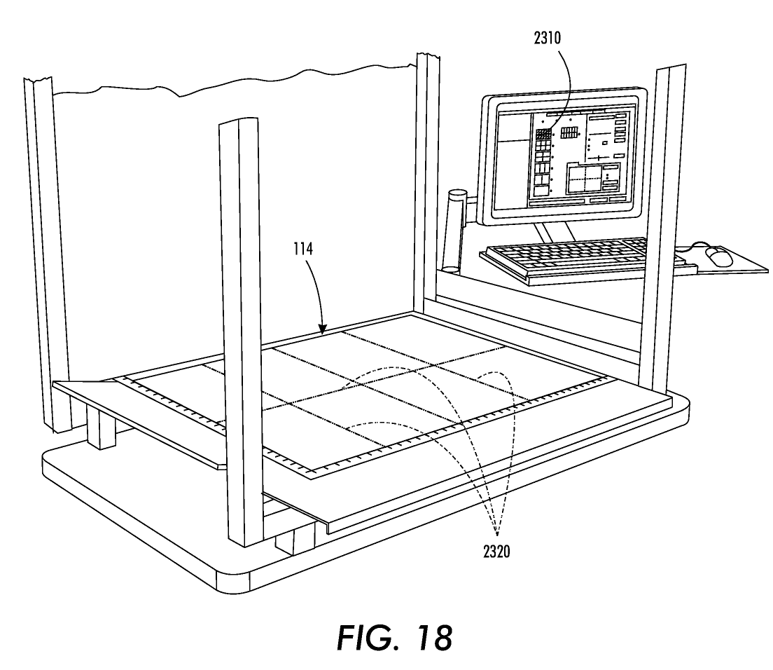

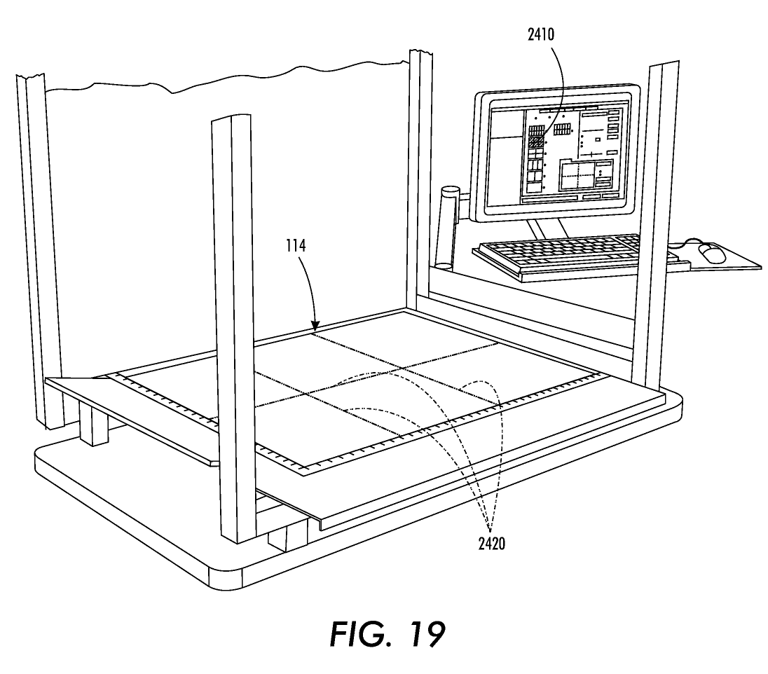

FIGS. 18 and 19 are close-up illustrations of the edge of platen 114, illustrating rulings that, in addition to the laser or other visual indicators, can assist the user with the positioning and imaging of a document(s) placed on the platen.

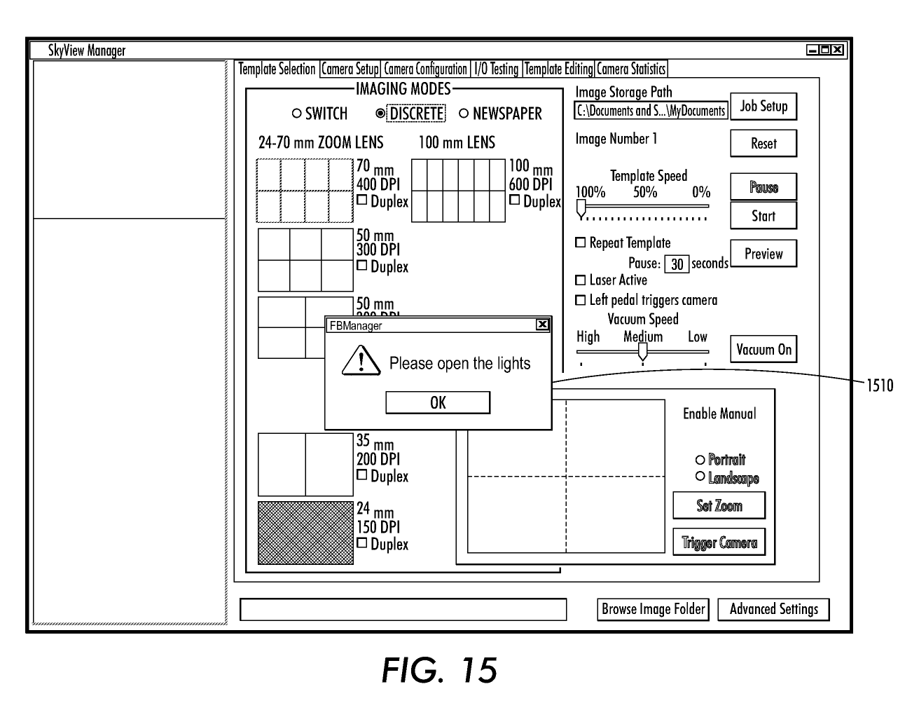

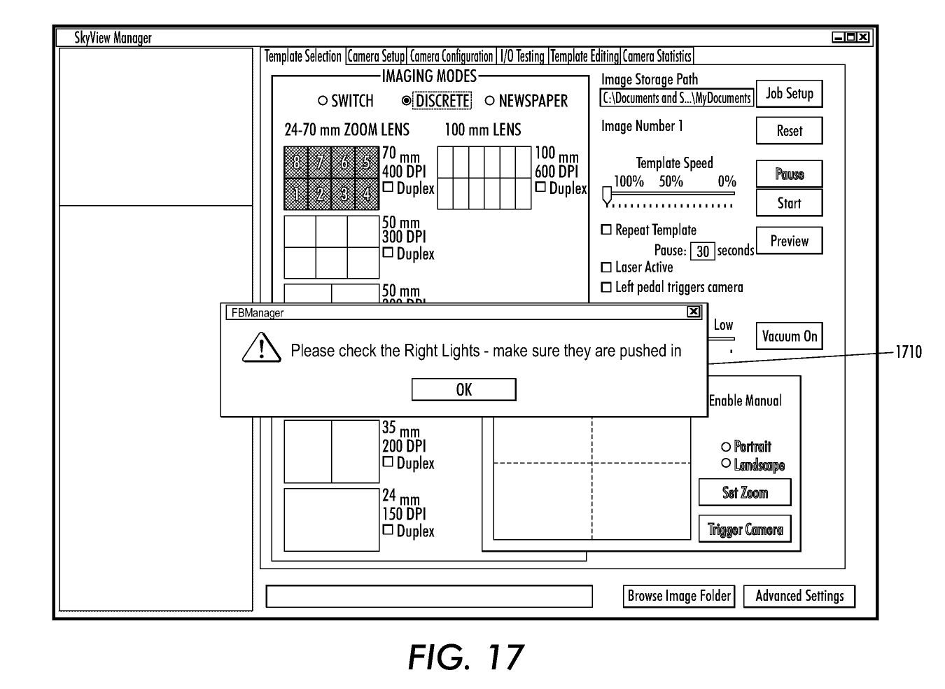

In FIGS. 14-17, an additional feature of system 100 is described and illustrated. Depending upon the configuration in which the imaging is carried out—full platen versus smaller sections for example—the lighting for the system may also be adjusted. For example, if the user selects the full-platen, landscape template, and the illuminators 106 (light boxes) are not extended to their full width, there may less light available along the leftmost and rightmost edges of the platen. To eliminate any possible decrease in illumination, the user is instructed, via a dialog box (1510, FIG. 15, center) to “open the lights,” meaning to move the illuminators to their maximum positions. An example of such a position is depicted in FIG. 16, where illuminator 106 is seen as extending beyond the edge of the system chassis. The position of the illuminator is monitored via sensors associated with the slides or tracks in which the illuminators move, in order to determine if the illuminator is in the maximum or minimum position. Once the user returns to imaging a section of the platen, the position of the illuminator lights is again tested, and if they are not in the minimum (closest) position, the user is presented with the dialog box 1710 (FIG. 17) instructing them to check the lights and to make sure they are pulled to maximize the illumination for the platen section imaging. It will be appreciated that the control of the illuminator position may also be carried out in an automated fashion, where the illuminators are positioned by a processor-controlled motor, solenoid or the like.

Referring to FIGS. 18 and 19, there are depicted two different template configurations and their associated illumination patterns on platen 114. For example, in FIG. 18, in response to the user's selection of the 8-up template 2310 on the user interface, the lasers defining the 2×4 grid are engaged and the grid 2320 is seen as contrasting light on platen 114. In actuality, the lasers are red, or other color, and are displayed in that color on the platen surface at which they are projected. Similarly, in FIG. 19, the selection of the 6-up portrait-oriented template results in the energizing of alternative lasers and the adjustment to the grid lines 2420 projected on platen 114.

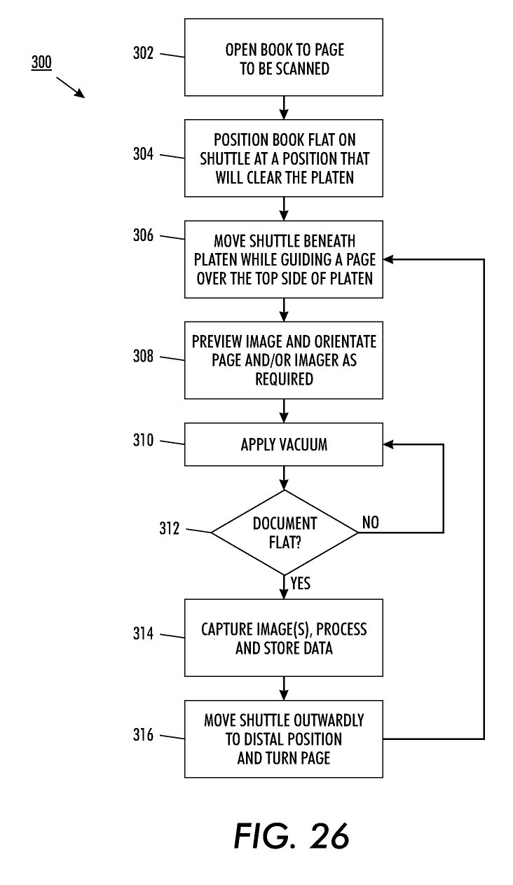

In the flowchart depicted in FIG. 26 a method or process 300 by which an overly large bound document is scanned is set forth. Initially, the book is opened in 302 and concurrently or subsequently positioned on the supporting surface of the shuttle, while the book is located at the second position (away from the platen edge). At 304, the book is positioned on the support surface of the shuttle according to the number of pages required to pass under the platen in step 306. Concurrently, while executing step 306 to slide the supported book toward and partially beneath platen 114, a page is held out or segregated so as to come into contact with the upper surface of the platen. The page may then be viewed as in 308 (operator view and/or a preview through the imager) to position the page within the imaging region. This step may also include adjustment of the imager position (left-right) and/or orientation (portrait—landscape). Once in position the page is flattened and secured by applying the vacuum in 310 and checked for flatness prior to imaging at 314. Consequently the image is recorded in memory during 314, the book is then moved away from the platen as depicted in 316 and the process repeated for subsequent pages. Although not depicted, it is understood that for multiple pages that are printed on both sides, the imaging order may be any one of a number of orders (e.g., all right-facing pages followed by inverting the book and imaging all left-facing pages—where the page images would then need to be interleaved to provide them in reading order).

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A large format imaging system, comprising:
a light source;
a platen, positioned below the light source;
an imager, adapted to receive light reflected off an item located on the platen from the light source; and
a position controller, for controlling the position of the imager in at least two dimensions relative to the platen such that the imager operates to sequentially capture a plurality of sections of the item located on the platen in a first mode and the entirety of the item located on the platen in a second mode.

2. The system according to claim 1, further including a user interface for selecting between a full platen imaging operation and a sectioned imaging operation.

3. The system according to claim 2, wherein said position controller is responsive to a user's selection of a template on the user interface.

4. The system according to claim 2, further including at least one visual indicator illustrating the user's selection of a sectioned imaging operation, wherein the visual indicator is observable relative to the platen and the item placed thereon.

5. The system according to claim 4, wherein said vacuum platen has a permeable imaging surface to attract said item.

6. The system according to claim 4, wherein the position controller regularly captures a section of the image and then automatically advances to the next section for capture automatically, thereby avoiding the need for the user to interact with the imager to capture a series of images.

7. The system according to claim 6, wherein a speed at which the position controller advances the imager between sections is selected by a user.

8. The system according to claim 1, wherein said light source includes a plurality of generally aligned baffles to provide aligned rays of light for reflection off of the item.

9. The system according to claim 1, wherein said platen is a vacuum platen and includes an open edge along at least a portion of one side.

10. The system according to claim 9, further including a book support, attached to a shuttle, said book support capable of traversing from a first position adjacent the platen open edge and a second position spaced apart therefrom.

11. The system according to claim 10, wherein said document shuttle, includes a surface positioned at an oblique angle with respect to said platen, and where said document shuttle is moveable along a path generally perpendicular to the open edge of the platen.

12. The system according to claim 1, wherein said imager operates in at least a portrait orientation and a landscape orientation.

13. The system according to claim 1, wherein said item is a document;

14. The system according to claim 13, wherein said document is a bound document.

15. The system according to claims 14, wherein said bound document is a large-format publication.

16. The system according to claim 1, wherein said item is a collection comprising a plurality of individual pieces.

17. A large-format book imaging system, comprising:
a chassis for supporting various components in a defined relationship;
a light source;
a vacuum platen, positioned below the light source, and having an open edge along at least a portion of one side thereof;
an imager, adapted to receive light reflected off a book page located on the platen from the light source; and
a book support attached to a shuttle capable of traversing from a first position adjacent the platen open edge and a second position spaced apart therefrom.

18. The system as defined in claim 17, wherein the document shuttle, includes an oblique angle with respect to said platen, and is moveable along an axis perpendicular to the open edge of the platen.

19. The system as defined in claim 17, further including a bound document placed on the support with at least one page segregated from the rest and placed on the platen and other pages of the bound document remaining supported by the book support and positioned beneath said platen.

20. The system as defined in claim 19, wherein said vacuum platen has a permeable scanning surface to attract said page.

21. The system as defined in claim 20, wherein said platen further includes a removable scanning surface.

22. The system as defined in claim 21, wherein said removable scanning surface is a felt overlay.

23. The system as defined in claim 17 wherein said shuttle includes rollers that engage with a slide rail associated with the chassis, and the shuttle translates along a path defined by the rail.

24. The system as defined in claim 17, further including a position controller, for controlling the position of the imager in at least two dimensions relative to the platen such that the imager operates to sequentially capture a plurality of sections of the book page located on the platen in a first mode and the entirety of the book page located on the platen in a second mode.

25. A method for imaging a large document, including:
placing a page of said document on a top surface of the platen;
positioning said page on the top surface of the platen; and
capturing an image of the upper surface of said page.

26. The method according to claim 25, wherein said document is a multi-page bound document, and further including:
placing said multi-page bound document on an oblique surface of a shuttle located at a first position adjacent said platen; and
moving the shuttle and document to a second position adjacent an open edge of a vacuum platen, wherein a portion of the document extends beneath the platen while a segregated page is held on a top surface of the platen
